(19) United States
(12) Patent Application Publication
(10) Pub. No.: US 2024/0013998 A1
(43) Pub. Date: Jan. 11, 2024

(54) FUSE AND METHOD OF PRODUCING A FUSE

(71) Applicant: SIBA Fuses GmbH, Lünen (DE)

(72) Inventor: Jens Weber, Dortmund (DE)

(73) Assignee: SIBA Fuses GmbH, Lünen (DE)

(21) Appl. No.: 18/007,301

(22) PCT Filed: Mar. 31, 2022
(86) PCT No.: PCT/EP2022/058557

§ 371 Date: Jan. 30, 2023

(30) Foreign Application Priority Data
May 5, 2021 (DE) 10 2021 002 383.8

(51) Int. Cl. H01H 85/175; H01H 69/02; H01H 85/041; H01H 85/143

(52) U.S. Cl. CPC H01H 85/175; H01H 69/02; H01H 85/0411; H01H 85/143; H01H 2085/0412; H01H 2085/0414

(57) ABSTRACT

The invention relates to a fuse (1), in particular SMD fuse, with an insulating housing (2) having a cavity (3), a (4) arranged in the cavity (3) of the insulating housing (2), and contact means (5) electrically connected to the melting conductor (4) for making contact with the outside of the fuse (1), wherein the insulating housing (2) comprises a base body (6) having the cavity (3) and a lid (7) closing the cavity (3) of the base body (6), wherein the contact means (5) are each arranged with an inner section (8) electrically connected to the melting conductor (4) in the interior of the insulating housing (2) and with an outer section (9) on the outer side (10) of the insulating housing (2), preferably of the base body (6).

### CROSS-REFERENCE TO RELATED APPLICATIONS

The present application is the U.S. national stage application of international application PCT/EP2022/058557, filed Mar. 31, 2022, which international application was published on Nov. 10, 2022, as International Publication WO 2022/233504 A1. The international application claims priority to German Patent Application No. 10 2021 002 383.8, filed May 5, 2021. The international application and German application are hereby incorporated by reference herein in their entireties.

### FIELD

The present invention relates to a fuse, in particular a SMD fuse, with an insulating housing having a cavity, a melting conductor arranged in the cavity of the insulating housing and contact means electrically connected to the melting conductor for contacting the fuse on the outside.

### BACKGROUND

A fuse and/or device protection fuse in the sense of the present invention is also referred to in the prior art as a so-called “fuse insert”, which can interact with a fuse holder. In this context, the fuse insert can be inserted into the fuse holder.

In the state of the art, the insulating housing is designed as an insulation body, wherein the external contacting of the fuse is ensured via contact means designed as contact caps. The contact caps are plugged onto the front side of the insulation housing.

If necessary, the fuse and/or fuse insert is filled with an extinguishing agent, in particular with sand, granules and/or glass beads, in particular with the extinguishing agent being arranged in the insulation housing. The insulation housing may be designed as an insulating tube. In practice, the melting conductor is inserted axially into the insulation housing. The electrical contact between the melting conductor and outer contact caps attached to the insulation housing is established by a solder connection. In addition, the solder joint also connects the outer contact caps to the insulation housing in a materially bonded manner.

The melting conductor is designed to carry the full load current during operation and, in particular, to interrupt an overload current and/or short-circuit current as quickly as possible.

SMD fuses are fuse inserts that can be mounted on printed circuit board surfaces (SMD—Surface Mounted Device). SMD fuses therefore belong to the technical field of surface-mounted technology (SMT). In surface mount technology, printed circuit boards are generally used as the surfaces to be assembled. In particular, SMD fuses are standardized in terms of their dimensions and electrical behavior—see DIN EN 60127-4 VDE 0820-4:2013-12 (as of April 2021) in this context.

A disadvantage of the fuse known from the prior art is that in some fuses the melting conductor shifts and/or is displaced in the insulation housing during fuse manufacture—after the melting conductor has been inserted into the insulation housing. Ultimately, the melting conductor does not remain in its intended mounting position. When the fuse is installed, the melting conductor may come into contact with the inner wall of the insulation housing and/or directly abut it. If the melting conductor is displaced in the insulation housing in this way, the switching behavior of the entire fuse changes and, in particular, no longer corresponds to the designed values. This is extremely disadvantageous, since each fuse is designed for specific values and is used in accordance with these values. A deviation from the designed values must therefore be avoided at all costs.

It is true that fuses with “displaced” melting conductors can be rejected by optical inspection procedures after the fuse has been manufactured. However, such a procedure is comparatively time-consuming and associated with high costs, especially since an optical inspection of each individual fuse must be carried out. Moreover, due to the particularly opaque insulation housing, this optical inspection can only be carried out as long as the outer contact caps are not yet in place. However, if there is a displacement of the melting conductor after or during the fitting of the outer contact caps, this can no longer be detected optically.

A further disadvantage of the fuse known from the prior art and/or of the method for producing fuses known from the prior art is that the connection of the melting conductor with the solder connection for electrical contacting of the outer contact caps is often insufficient for a permanent electrical connection. In particular, the forming of a so-called “solder ball”—a sphere made of the solder material—is required for electrical contacting between the melting conductor and the outer contact cap, but this often cannot be adequately ensured. Thus it happens that the solder and/or the solder material leaks into the space between the outer contact cap and the insulation housing, and thus there is no longer sufficient solder for an adequate electrical connection between the melting conductor and the outer contact caps.

### SUMMARY

It is therefore the object of the present invention to avoid the aforementioned disadvantages of the prior art or at least to substantially reduce them.

According to the invention, the aforementioned object is at least essentially solved in a fuse of the type mentioned above in that the insulation housing has a base body comprising the cavity and a lid closing the cavity of the base body, the contact means being arranged with in each case an inner section electrically connected to the melting conductor in the interior of the insulating housing and with in each case an outer section on the outside of the insulating housing, preferably of the base body. Ultimately, the base body is an open box with a bottom, front side walls and side walls, into which the melting conductor can be inserted and connected to the contact means in accordance with the invention. Until the lid is fitted to completely close the fuse, the melting conductor can be connected to the contact means without further ado.

In this context, it is understood that the melting conductor has and/or consists of an electrically conductive material. In addition, the insulating housing in particular has or consists of an electrically insulating material, so that the base body and the lid can also have and/or consist of an electrically insulating material.

Ultimately, the contact means can abut and/or adjoin the outer side of the insulation housing with the outer section. In particular, the outer sections of the contact means can project and/or protrude from the outside of the insulation housing. Via the contact means and/or via the outer sections of the contact means, contact can be made on the outside of the fuse, with the inner section ultimately being electrically connected to the melting conductor. Contact caps, as were necessary in the prior art, can be omitted in the invention.

In this context, it is understood that a plurality of contact means, preferably exactly two contact means, are provided.

Advantageously, the invention can avoid a costly optical and manual inspection process of the manufactured fuses. Consequently, the manufacturing costs of the fuse according to the invention—despite the necessary contact means—can be reduced compared to the fuses known from the prior art—due to the omission of discarded fuses—preferably by at least 10%. In addition, the invention ensures in particular that damage due to defective fuses cannot occur.

Furthermore, fuses can be provided in which it is ensured that the melting conductor is arranged in particular axially and/or centered in the insulating housing and/or base body. The inner sections of the contact means—by which the melting conductor is fixed in particular—can be used in particular to prevent the melting conductor from leaning against and/or striking the inner wall of the insulation housing—both immediately after manufacture and after a certain period of use.

Preferably, the melting conductor is arranged in the base body in a positionally stable manner. The fuse can be fixed at least indirectly by the inner sections of the contact means. In particular, the melting conductor can be placed in a defined position in the insulating housing, especially in the base body, and can also be securely fixed by the contact means. Unwanted contact of the melting conductor with the inner walls of the base body and/or the insulating housing can be avoided.

The fuse according to the invention can be designed both as a so-called cuboidal and/or square (SMD) fuse—i.e. a fuse with an at least essentially cuboidal insulation housing and/or a fuse with an at least essentially square cross-section—and as a cylindrical fuse—i.e. a fuse with an at least essentially cylindrical insulation housing and/or a fuse with an at least essentially circular cross-section. Cylindrical fuses can also be used as SMD fuses.

In addition, the inner sections of the contact means succeed in improving the electrical contact between the melting conductor and the outer sections of the contact means—especially since the melting conductor occupies a predetermined position in the insulating housing so that, in particular, the application of an electrical connecting agent and/or a solder connection can be carried out in a targeted and reliable manner.

According to the invention, the arrangement of the melting conductor and in particular the entire manufacture of the fuse is simplified because the melting conductor can be arranged in the insulating housing via the cavity of the base body, in particular via an insertion opening of the cavity of the base body, and can be electrically connected to the inner sections of the contact means. By the contact means having both an inner and an outer section, a more reliable electrical contacting of the melting conductor is ensured. Also, it can be avoided that an undesired placement of the melting conductor is not detected. Thus, the arrangement of the melting conductor in the base body can be visually checked before inserting the lid and/or before connecting the lid to the base body. A predetermined arrangement of the melting conductor at the inner sections is also useful in that incorrect positioning can be at least substantially reliably avoided.

In a preferred embodiment, it can be provided that the melting conductor can be arranged on and/or at a carrier means and/or carrier material, in particular applied and/or wound up. In particular, at least one glass fiber and/or a glass fiber core can be provided as the carrier means. In this context, it is understood that preferably the carrier means is connected together with the melting conductor to the inner sections, preferably is fixed. The carrier means can extend in areas or completely over the length of the melting conductor.

Preferably, the melting conductor has a central region enclosed by end-side regions. The end-side regions are the outer regions of the melting conductor, which may include—but are not limited to—the outer ends and/or the outer front sides of the melting conductor. In particular, the end-side region of the melting conductor may correspond, for example, to at least 2% of the length of the melting conductor in each case, preferably between 2% to 45%, more preferably between 3% to 10%. In this context, it is also understood that the lengths of the end-side regions may differ from each other.

In addition, the melting conductor can be designed as an elongated wire.

In particular, the preferably elongated melting conductor can be fixed in the region of its ends and/or in the end-side regions by the inner sections of the contact means. In this context, it is understood that a section of the melting conductor can also project beyond the connection and/or fixing point on the inner sections of the contact means. Accordingly, the fixing point at the inner sections does not necessarily have to form the outer end and/or the outer front side of the melting conductor.

In particular, the melting conductor is at least substantially tensioned and/or taut between the inner sections and/or the fixing points.

In this context, it is understood that “fixing point” according to the invention means the point at which the melting conductor is connected to the contact means, in particular the inner section of the contact means.

In addition, the length of the melting conductor can exceed the length of the insulating housing, in particular the length of the base body, especially if the melting conductor is wound on a carrier means, or be at least substantially equal to the latter. Alternatively, it can be provided that the melting conductor has a shorter length than the length of the insulating housing.

Preferably, the melting conductor may be arranged entirely within the insulating housing, with external contacting of the melting conductor via the outer portions of the contact means.

In addition, the insulating housing, the base body and/or the lid may comprise and/or consist of an electrically insulating material such as glass and/or ceramic.

The melting conductor can have as material an electrically conductive material, preferably metal, and/or consist of it. In particular, copper, nickel, steel, gold and/or silver are used as materials for the melting conductor. In addition, the melting conductor may also have as material a metal alloy, for example a silver and/or copper alloy.

The melting conductor can be formed as a melting conductor wire and/or as a melting conductor strip. Furthermore, the melting conductor may have an at least substantially circular and/or elliptical or an at least substantially rectangular cross-section.

In addition, the melting conductor can be provided with constrictions by means of which a more nimble or more sluggish overload and/or short-circuit behavior can be set. The constrictions can, in particular, take the form of cross-sectional constrictions.

In a particularly preferred embodiment, it is provided that in each case the inner section of the contact means for making electrical contact with the melting conductor is adjacent to the cavity and/or projects into the cavity. Thus, the inner section can be flush with the (inner) wall of the cavity or set back relative to it—wherein accessibility for electrical contacting of the inner section is ensured, for example by snapping the melting conductor into a corresponding opening in the (inner) wall of the base body.

In any case, however, it is particularly the case that the contact means passes through the bottom and/or a wall of the insulating housing and is designed in such a way that electrical contacting and, in particular, connection with the melting conductor is possible on the outside.

Preferably, the cavity has an insertion opening for inserting the melting conductor. The insertion opening can be formed in particular on the upper side of the fuse, with the front sides and the longitudinal side of the base body forming the insertion opening. Thus, the melting conductor can be inserted into the cavity via the upper side and not via the front sides. Particularly preferably, the fuse has a single insertion opening. The insertion opening can preferably be completely closed by the lid. Thus, the melting conductor can first be connected to the inner sections of the contact means via the insertion opening, and the lid can then be placed on the lid to close the insertion opening.

Preferably, a plurality of melting conductors is provided. Particularly preferably, the melting conductors are connected in parallel. In this context, it is understood that the aforementioned arrangement in the insulation housing and/or in the base body is provided for all melting conductors. The melting conductors are electrically connected to the contact means.

Advantageously, the parallel connection of at least two melting conductors can increase the rated current and thus further results in advantageous properties when extinguishing the arc produced when the fuse is tripped. Alternatively or additionally, the advantage arises that a better switching behavior is achieved at the same rated currents compared to only one melting conductor, since the current can be distributed over at least two melting conductors. In particular, exactly two melting conductors can be provided.

In another preferred embodiment, exactly a single melting conductor is provided.

Furthermore, it is preferred that the insertion opening is elongated, with the longitudinal extension of the insertion opening—which runs in particular along a longitudinal side and not along a front side—running in the longitudinal extension of the base body. The base body can preferably also be of elongated design. Thus, the longitudinal extension of the insertion opening can in particular be aligned at least in the longitudinal extension of the base body. Preferably, the insertion opening extends substantially over the entire length and/or width of the cavity.

The base body can preferably have an at least substantially rectangular and/or square cross-section. In particular, the base body is designed as a box that is open on a top side and has a cavity on the inside. Thus, the base body may in particular have a box-like shape open at the lid side.

In addition, in a further preferred embodiment, it is provided that the lid is detachably or fixedly connectable and/or connected to the base body. Thus, after insertion of the melting conductor into the cavity and after connection of the melting conductor to the inner sections of the contact means, the lid can be either detachably or non-detachably and/or inseparably connected to the base body. Ultimately, the lid is connected to the main body after the melting conductor is inserted into the cavity. The lid can have corresponding locking means, in particular locking contours, for latching, positive and/or frictional connection to the base body. In particular, the base body can have complementary locking means, in particular locking contours, on the edge sides provided for this purpose. Bonding or welding may also be provided.

In a further, particularly preferred embodiment, it is provided that the lid rests on the base body and/or that the lid turns the base body upside down, at least in certain areas. In particular, the lid can turn the base body upside down at least in part on at least substantially one edge side. Ultimately, the lid enables an at least substantially flush closure of the base body. Thus, the lid can ensure that no undesirable components, such as external gases or a liquid, can enter the cavity. The melting conductor and the cavity are consequently protected from external influences via the lid. This ensures in particular the correct functioning of the fuse.

Furthermore, in a further preferred embodiment of the idea of the invention, it is provided that the lid is firmly connected, in particular materially connected, to the base body and/or that the lid can be connected to the base body in a form-fitting and/or friction-fitting manner, preferably in a latching manner Thus, the lid can be designed in such a way that an aforementioned type of connection to the base body can be made possible. In particular, the lid can be latched in the base body, which ensures a simple arrangement and connection of the lid to the base body.

Preferably, the contact means is guided through the base body from the outside into the interior of the insulating housing, in particular in such a way that it is adjacent to the cavity or projects into it. In particular, the contact means can be guided through at least one side wall and/or front side wall and/or the bottom of the base body. The contact means can be firmly connected to the base body and/or held in the base body. In particular, the lid is separate from the contact means and thus serves exclusively to close the insulation housing. Thus, the contact means is preferably guided only through at least one wall of the base body—that is, either the side walls and/or the bottom wall—but not through the lid, which may form the top of the insulating housing.

Accordingly, the lid can be formed externally and/or internally free of the contact and/or the arrangement of the contact means.

Preferably, at least one contact means, in particular both contact means, is arranged in contact with the bottom side of the base body facing away from the lid and/or with at least one longitudinal side and/or front side of the base body, at least in sections. This applies both on the inside and on the outside.

Preferably, it is provided that the outer section at least partially and/or regionally, preferably completely, abuts and/or directly adjoins the outer side of the insulating housing, preferably of the base body. In particular, the outer section at least partially surrounds the base body and/or the insulating housing. Ultimately, the outer section of the contact means may not protrude with respect to the base body and/or the insulating housing, but may nestle against and/or abut and/or arrange against the base body and/or the insulating housing. Preferably, the outer section of the contact means protrudes only by at most twice the, in particular maximum, material thickness of the outer section relative to the outside of the insulating housing and/or the base body.

The aforementioned arrangement of the outer sections has the advantage of a simplified arrangement of the fuse on a printed circuit board, which is useful when using the fuse as a SMD fuse. In the case of a SMD fuse, the fuse is placed on and/or against a printed circuit board.

Particularly preferably, the outer section wraps around the base body and/or the insulating housing, preferably in a corner area, in such a way that the outer section rests in areas, in particular directly, against the bottom, a front side and possibly both longitudinal sides and/or at least one longitudinal side. In this context, it is understood that the outer section need only extend over part of the bottom, front side and/or longitudinal side surface in each case.

Accordingly, it is particularly preferred if the contact means for forming the outer section emerges from the interior of the insulating housing on the underside and/or bottom of the base body facing away from the lid. The outer section of the contact means can thus be arranged on the underside and/or bottom of the base body.

Preferably, the inner section of the contact means—i.e. the section arranged in the interior of the insulating housing—has an angulation and/or a recess and/or indentation at least in one area and/or is angled in at least one area. Thereby, the inner section can be at least partially S-shaped or curved. Preferably, the inner section is arranged at least partially parallel to a corresponding front side of the base body. The front sides of the base body can be arranged on opposite sides of the base body. The preferably curved angulation enables in particular better retention and/or fixing of the contact means on the base body and/or provides an enlarged contact surface for external contacting on the outer section.

Preferably, the contact means as a whole is formed in one piece. Alternatively or additionally, it may be provided that the inner and outer sections of the contact means are formed integrally with one another and, in particular, merge at least substantially directly into one another. Preferably, the inner and outer sections are made of the same material.

Alternatively, it can also be provided that the inner and outer sections are formed as separate parts, wherein the aforementioned components can be electrically connected to one another via a connecting part and are formed in particular from an electrically conductive material, preferably metal. Thereby, the inner and/or the outer section can be formed as a metal piece, metal wire and/or metal sheet.

It is particularly preferred that the contact means, in particular the outer and/or the inner section, has metal and/or is made of metal. Preferably, the contact means, in particular the inner and/or the outer section, has no solder and/or is formed free of a solder connection.

In a further particularly preferred embodiment, it is provided that a contact means is arranged at least partially on opposite front sides of the base body in each case. Alternatively or additionally, the contact means can also be arranged on opposite sides on the underside and/or bottom of the base body.

Preferably, one end-side region of the melting conductor is connected to a connection region of a contact means in each case. The connection region can ensure an electrical and/or mechanical connection. The melting conductor does not have to be connected in the region of its front sides to the inner sections of the contact means, in particular via a solder connection.

Furthermore, the inner section of the contact means preferably has a receptacle. The receptacle can be designed for the respective arrangement of an end-side region of the melting conductor. In this context, it is understood that the end-side region and not necessarily the front side of the melting conductor must be accommodated or arranged in the receptacle. The receptacle can be formed as a recess and/or indentation of the inner section and, in particular, corresponding to the outer shape of the melting conductor.

Preferably, the inner section and/or the receptacle of the inner section is designed in such a way that the melting conductor is fixed, in particular clamped, in a frictionally engaged manner at least at one end-side region and/or is connected in a materially engaged manner to the inner section and/or the receptacle of the inner section. In this way, the melting conductor can be securely fixed in particular to or in the receptacle.

Furthermore, the inner section of the respective contact means can be electrically connected to the end-side region of the melting conductor via a fastening means, in particular a solder connection, a conductive adhesive connection and/or via a crimped connection. Finally, the melting conductor can be enclosed and/or clamped between two inner sections of the contact means and thus fixed in the cavity.

In addition, the contact means can be inserted into the insulating housing, in particular into the base body. Alternatively or additionally, it can be provided that the contact means is detachably connected to the insulating housing, in particular the base body. Preferably, both contact means are detachably connected to the insulating housing, in particular the base body. Insertion of the contact means allows easy insertion of the inner section of the contact means into the interior of the insulating housing.

Alternatively, it can be provided that the contact means are firmly, preferably inseparably, connected to the insulating housing, in particular to the base body. A fixed connection between the contact means and the base body can be achieved during manufacture, in particular during manufacture of the base body and/or the insulation housing. For example, the base body may be formed around the contact means, preferably by an injection molding process and/or a master molding process of the material of the base body. Preferably, in the injection molding process, plastic material of the base body is processed and injected in a liquefied and/or plasticized form, preferably under pressure—to form the shape of the base body. In principle, other manufacturing processes of the base body are also possible.

In particular, the cavity can be at least partially filled with an extinguishing agent. The extinguishing agent may be extinguishing sand, in particular quartz sand. The extinguishing agent enables an arc to be extinguished when the fuse is tripped, thereby increasing the safety and/or the switching capacity and/or the switching performance of the entire fuse.

The extinguishing agent can in particular comprise an extinguishing sand with a preferably fixed particle size distribution, which is preferably suitable for use in the fuse link. In addition, colored sands, sand and/or ceramic chips and/or glass beads can also be used as extinguishing agents.

In addition, the base body can have a recess, preferably a central one. The recess can be arranged, for example, between the inner sections of the contact means. In particular, a free space can be provided under the melting conductor. Thus, the melting conductor can be arranged in the cavity at the inner sections, in particular the receptacles of the inner sections, in such a way that a free space is provided below the melting conductor—that is, facing away from the lid—which can be filled, for example, with an extinguishing agent, in particular an extinguishing sand, at least partially, preferably completely.

Furthermore, the present invention relates to a method for producing a fuse according to one of the aforementioned embodiments, wherein the method comprises the following method steps, which are preferably carried out in succession:
A) Provide the insulating housing, melting conductor and contact means;
B) Inserting the melting conductor into the cavity of the base body of the insulating housing;
C) Electrical connection of the melting conductor to the inner sections of the contact means;
D) Closing the cavity of the base body with the lid.

In connection with the method according to the invention, reference may be made to the aforementioned preferred embodiments of the fuse according to the invention as well as advantages of the fuse, which apply in the same way to the method according to the invention, in particular without this requiring further explicit mention. At the same time, the process features indicated below also apply in the same way to the previously explained fuse according to the invention. Accordingly, in order to avoid unnecessary repetition, reference is made to the above explanations.

In this context, it is understood that the insulating housing can also be manufactured after the contact means have been provided, in particular wherein the base body of the insulation housing can be formed around the contact means, for example by a plastic processing method, in particular an injection molding method. Thus, it can be provided that the insulation housing, in particular the base body, can already be firmly connected to the contact means during manufacture. Ultimately, the contact means penetrate the bottom and/or the walls of the base body and are accessible on the inside and outside.

Preferably, in particular after step B) and in particular before step D) is carried out, an extinguishing agent can be introduced into the insulating housing, in particular into the cavity of the insulating housing. In particular, extinguishing sand, granules and/or glass beads are provided as the extinguishing agent.

In particular, it is provided that the interior of the insulating housing—i.e. the cavity—is not completely filled with the extinguishing agent. Preferably, the cavity of the insulating housing is at least partially filled with the extinguishing agent.

Preferably, the melting conductor is inserted into the cavity of the insulating housing via the insertion opening of the base body. As explained above, the insertion opening can be elongated in the longitudinal direction of the base body. In particular, the length of the insertion opening has at least the length of the melting conductor in the inserted state. In this context, “length of the melting conductor” is to be understood as that length and/or longitudinal extension which the melting conductor occupies in the actually inserted state—for example, the length of the carrier means. If, for example, the melting conductor is wound on a carrier means, the length and/or longitudinal extension of the melting conductor in the inserted state is smaller than the length of the melting conductor in the extended state. The insertion opening is ultimately designed in particular in such a way that the melting conductor—in its form corresponding to the state of use—can be easily inserted into the cavity. In particular, the insertion opening is not formed on the front side of the base body.

The melting conductor can be connected in the end-side regions to the inner section of the contact means and/or the receptacle of the inner section of the contact means with a fastening means, such as a conductive adhesive and/or a solder connection. This connection is preferably provided before carrying out step D). In this way, a material connection between the inner section and the end-side region of the melting conductor can be made possible. Preferably, the melting conductor is firmly connected to two contact means—i.e. to two inner sections of the contact means—at two end-side regions, in particular by a material bond, a friction bond and/or a form-fit.

In particular, the melting conductor can be centered in the insulating housing, which is especially advantageous for the behavior of the fuse.

Furthermore, it is understood that any intermediate intervals and individual values are included in the above-mentioned intervals and range limits and are to be regarded as disclosed as essential to the invention, even if these intermediate intervals and individual values are not specifically indicated.

Further features, advantages and possible applications of the present invention will be apparent from the following description of examples of embodiments based on the drawing and the drawing itself. In this context, all the features described and/or illustrated constitute the subject-matter of the present invention, either individually or in any combination, irrespective of their summary in the claims or their relation back.

### BRIEF DESCRIPTION OF THE DRAWINGS

It shows:

FIG. 1 is a schematic perspective view of a fuse according to the invention,

FIG. 2 is a schematic side view of the fuse shown in FIG. 1,

FIG. 3 is a schematic side view of a lid according to the invention,

FIG. 4 is a schematic cross-sectional view of a further embodiment of a fuse according to the invention,

FIG. 5 is a schematic cross-sectional view of a further embodiment of a fuse according to the invention,

FIG. 6 is a schematic top view of a base body according to the invention with inserted melting conductor,

FIG. 7 is a schematic perspective view of a further embodiment of a fuse according to the invention,

FIG. 8a is a schematic cross-sectional view of the fuse shown in FIG. 7,

FIG. 8b is a schematic perspective view of a contact means according to the invention,

FIG. 9 is a schematic cross-sectional view of a further embodiment of a fuse according to the invention,

FIG. 10 is a schematic cross-sectional view of a further embodiment of a fuse according to the invention,

FIG. 11 is a schematic cross-sectional view of a further embodiment of a fuse according to the invention,

FIG. 12 is a schematic cross-sectional view of a further embodiment of a fuse according to the invention, and

FIG. 13 is a schematic representation of a method according to the invention for producing a fuse.

### DETAILED DESCRIPTION

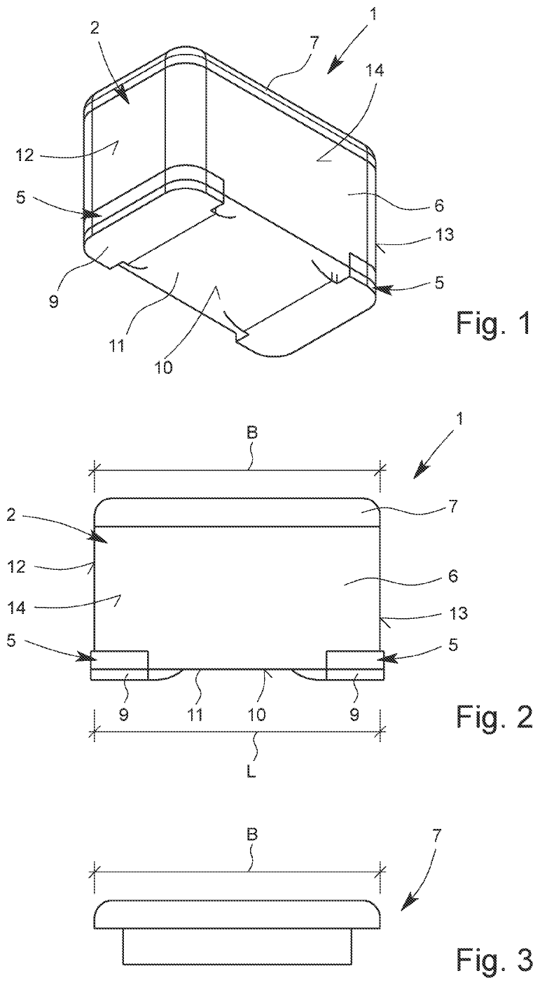

FIG. 1 shows a fuse 1 which can be used in particular as a SMD fuse. It is not shown that the fuse 1 can be arranged on and/or at a printed circuit board and in particular be firmly connected to the printed circuit board, preferably by a material connection, a friction connection and/or a form-fit connection.

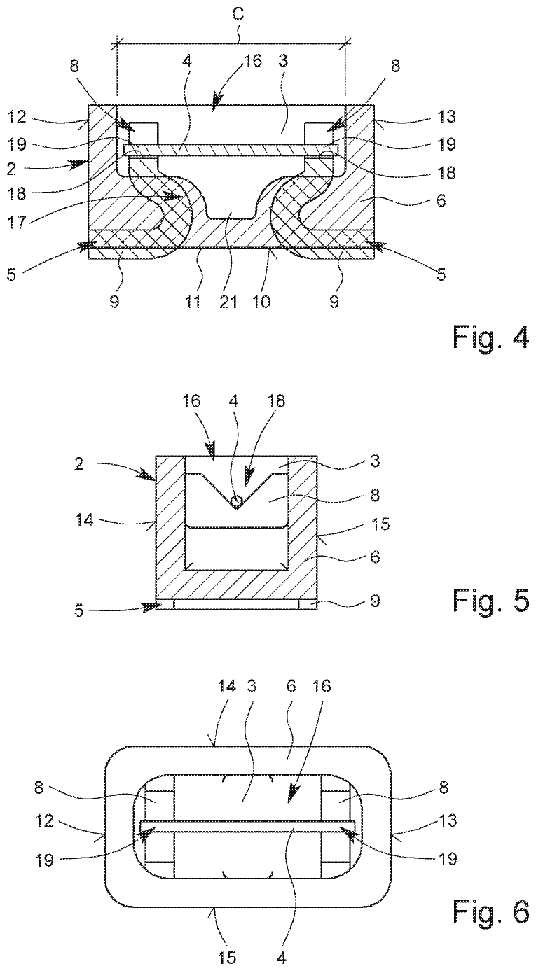

The fuse 1 shown in FIG. 1 has an insulating housing 2. FIG. 1 does not show that a cavity 3 is provided inside the insulating housing 2. The cavity 3 can be seen from the cross-sectional view shown in FIG. 4. The insulating housing 2 consists of an electrically insulating material.

FIG. 4 shows that a melting conductor 4 is arranged in the cavity 3 of the insulating housing 2.

Not shown is that a plurality of melting conductors 4 may be disposed in the cavity 3.

In particular, it is not shown that at least two melting conductors 4 are arranged in the cavity 3. The melting conductors 4 can be connected in parallel. Preferably, the rated current can be increased by connecting the melting conductors 4 in parallel.

The melting conductor 4 is electrically connected to contact means 5. The contact means 5, which are also shown in FIG. 1, are used for external contacting of the fuse 1 and thus enable external contacting of the melting conductor 4 enclosed inside the insulating housing 2.

In FIG. 1, it is shown that the insulating housing 2 has a base body 6 comprising the cavity 3 and a lid 7 closing the cavity 3 of the base body 6 and/or the base body 6. In particular, both the lid 7 and the base body 6 are formed from an electrically insulating material.

The base body 6 can have an at least essentially elongated cuboid shape, in particular in the form of a box, as shown in FIG. 1. The corners of the base body 6 may—but need not—be rounded. In particular, the base body 6 is of elongated design and has a longitudinal extension L. In particular, the lid 7 can have a longitudinal extension B which runs in the longitudinal extension L of the base body 6. The cross-sectional shape of the lid 7 can be designed to correspond to the cross-sectional shape of the base body 6, so that ultimately the lid 7 can close the base body 6.

FIG. 4 shows that two contact means 5 are provided. Each contact means 5 has an inner section 8 and an outer section 9. The inner section 8 is arranged inside the insulating housing 2. The inner section 8 is further guided in particular by a wall of the base body 6. The inner section 8 is considered to be that section of the contact means 5 which is not arranged on the outer side 10 of the base body 6 and/or the insulating housing 2. The melting conductor 4 is electrically connected to the inner section 8. In this context, the melting conductor 4 may be directly or indirectly mechanically connected to the inner section 8. A conductive connection may also be provided between the inner section 8 and the melting conductor 4—for example, a conductive adhesive connection and/or a solder connection.

The contact means 5 further comprises the outer section 9 arranged on the outer side 10 of the insulating housing 2. In particular, the outer section 9 is arranged on the outer side 10 of the base body 6.

Preferably, the outer section 9 is not arranged on the outside of the lid 7.

In FIG. 1, it is shown that the outer section 9 is arranged on the bottom 11 of the base body 6, the bottom 11 being arranged on the side of the base body 6 opposite the lid 7.

The outer section 9 can also be arranged on the front sides 12, 13 of the base body 6, at least in certain areas. Alternatively or additionally, it may be provided that the outer section 9 of the respective contact means 5 is arranged on the longitudinal sides 14, 15 of the base body 6 extending in longitudinal direction L. In particular, the base body 6 can have a bottom 11, front sides 12, 13 and longitudinal sides 14, 15 and thus have a box shape, as this is shown schematically in FIG. 1.

FIG. 8a shows that the outer section 9 for contacting is arranged only on the bottom 11, at least in some areas, and/or protrudes beyond it.

In further embodiments not shown, it may be provided that the outer section 9 for contacting is provided at least in areas on the bottom 11 and/or the front sides 12, 13 and/or the longitudinal sides 14, 15. Ultimately, the outer section 9 is adapted to respective contacting situations and is designed in such a way that simple and safe contacting of the fuse 1 can take place.

In FIG. 11 and in FIG. 12 it is shown that the outer section 9 is arranged at the front sides 12, 13.

Not shown is that the outer section 9 can also be arranged only on the longitudinal sides 14, 15.

In particular, the contact means 5 is connected to the base body 6 in such a way that it is possible to prevent the contact means 5 from falling out of and/or accidentally detaching from the base body 6.

FIG. 8a shows that the contact means 5 can project with its outer section 9 over the outer side 10 of the insulating housing 2 and the base body 6. It is not shown that in further embodiments the contact means 5 with its outer section 9 can be flush with the outer side 10 for external contacting of the fuse 1. Ultimately, the outer section 9 basically enables contacting on the outside.

In FIG. 4, it is shown that the inner section 8 of the contact means 5 for making electrical contact with the melting conductor 4 projects into the cavity 3. Alternatively, it may be provided that the inner section 8 adjoins the cavity 3, as shown schematically in FIG. 12. In such an embodiment, the inner section 8 can be at least substantially flush with the inner wall of the base body 6 or set back relative to the inner wall of the base body 6 but still be accessible for the arrangement of the melting conductor 4, which can, for example, engage in a corresponding opening in the inner wall of the base body 6.

In FIG. 4, it is also shown that the cavity 3 has an insertion opening 16 provided opposite the bottom 11. In particular, exactly one single insertion opening 16 is provided for inserting the melting conductor 4. The insertion opening 16 may in particular be at least substantially completely closable by the lid 7. The lid 7 can in principle be formed in one or more parts.

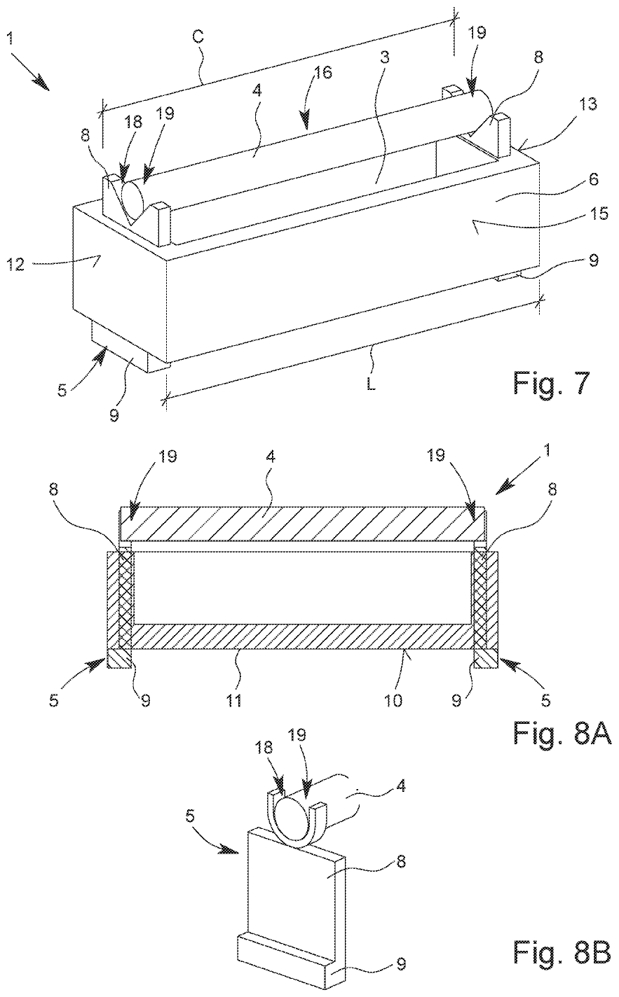

FIG. 7 shows that the insertion opening 16 is elongated, with the longitudinal extension C of the insertion opening 16 extending at least substantially in the direction of the longitudinal extension L of the base body 6.

In particular, the insertion opening 16 is not arranged on the front sides 12, 13 of the fuse 1.

The lid 7 can be detachably or firmly connected to the base body 6. In particular, the lid 7 can snap into the base body 6.

FIG. 1 shows that the lid 7 rests on the base body 6, with the lid 7 preferably turning over the base body 6 at least in some areas on all edge sides.

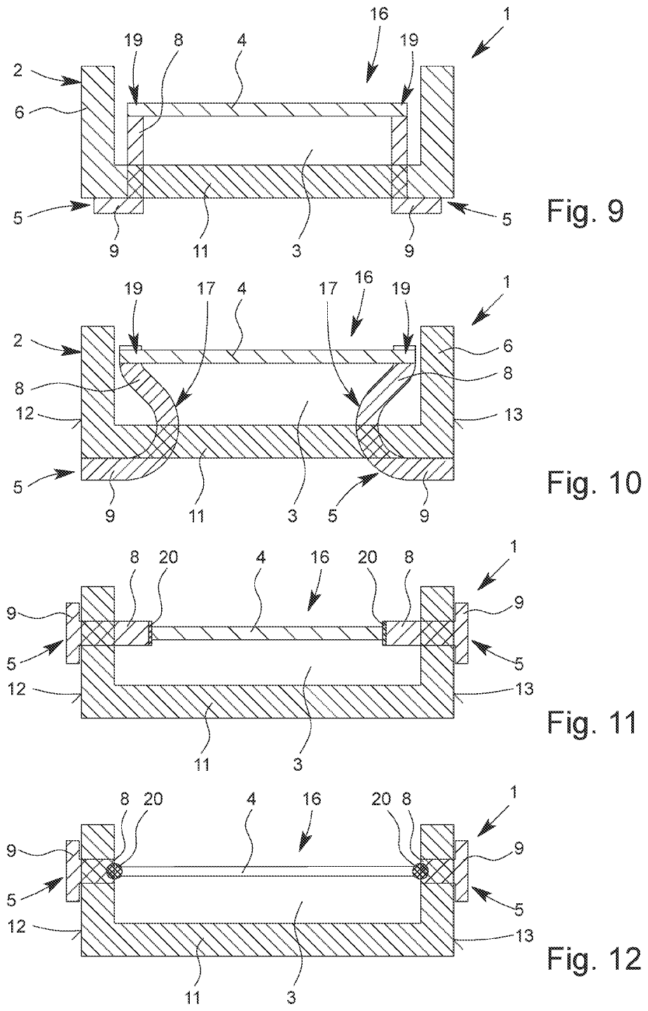

FIG. 9 shows that the outer section 9 at least partially, preferably completely, abuts and/or is directly adjacent to the outer side 10 of the insulating housing 2, in particular the base body 6.

FIG. 1 shows that the outer section 9 at least partially turns over the base body 6 and/or the insulating housing 2. In the embodiment example shown in FIG. 1, the outer section 9 directly abuts both the respective front sides 12, 13 and the bottom 11. In particular, the outer section 9 may also abut the longitudinal sides 14, 14 at least in some areas. Particularly preferably, the outer section 9 wraps around the base body 6 in such a way that the outer section 9 rests in areas, in particular directly, against the bottom 11, against a front side 12 or 13 and, if appropriate, against both longitudinal sides 14, 15. Such an arrangement is particularly suitable for SMD fuses 1 for arrangement on a printed circuit board not shown in greater detail.

FIG. 10 shows that the outer section 9 rests and/or nestles against the bottom 11 in certain areas and directly adjoins the latter. In particular, the outer section 9 can only protrude and/or project by at most twice the preferred maximum material thickness and/or thickness of the outer section 9 relative to the outer side 10 of the base body 6 and/or the insulating housing 2.

Not shown is that in further embodiments the lid 7 may be recessed relative to the outer edge sides of the base body 6, in particular so as to form a step, the lid 7 continuing to lid the cavity 3 in particular.

The lid 7 shown in FIGS. 1 and 2 is shown in a side view in FIG. 3. The lid 7 shown in FIG. 3 can be connected to the base body 6 in a form-fitting and/or friction-fitting manner, preferably in a latching manner. It is not shown that the lid 7 is firmly connected to the base body 6 by a material bond.

For illustrative reasons, the lid 7 is not shown in FIGS. 4 to 12.

The contact means 5 shown in FIG. 4 and/or the two contact means 5 shown in FIG. 4 are guided into the interior of the insulating housing 2 through at least one wall of the base body 6—in the embodiment example shown in FIG. 4, the bottom 11. The contact means 5 are firmly held in the base body 6. The lid 7 serves exclusively to close the base body 6, is free of punctures and is designed independently of the contact means 5.

In FIGS. 11 and 12, a further embodiment of the fuse 1 is shown, wherein the lid 7 is not shown in detail for schematic view. In addition, a cross-sectional view has been selected to schematically illustrate the arrangement of the contact means 5. In the embodiment examples shown in FIGS. 11 and 12, it is provided that the contact means 5 are guided through the front sides 12, 13 of the base body 6. In principle, it can also be provided that in further embodiments not shown, at least one contact means 5 is guided through a longitudinal side 14, 15 of the base body 6. As previously explained, this ultimately depends on the respective contacting situation.

In FIG. 8a it is shown that the outer section 9 of the contact means 5 rests against the bottom 11 of the base body 6 at least in sections. In the embodiment example shown in FIG. 1, on the other hand, it is provided that the outer sections 9 of the contact means 5 rest not only in sections against the bottom 11, but also against the front sides 12, 13 and, at least in one area, against the longitudinal sides 14, 15. In the case of the contact means 5 shown in FIG. 1, it is provided that this extends over the entire length of the front sides 12, 13 and only over a smaller part of the length of the longitudinal sides 14, 15, in particular at most 40%, preferably at most 20%, further preferably at most 15%.

In the embodiment examples shown in FIGS. 11 and 12, it is provided that the outer section 9 of the contact means 5 extends at least partially at the front sides 12, 13 and in particular extends over at least 10%, preferably at least 30%, more preferably between 30% to 90%, of the length of the front sides 12, 13.

In the embodiment examples shown in FIGS. 9 and 10, the outer section 9 of the respective contact means 5 extends only on the underside and/or over the bottom 11 and in each case preferably occupies at least 10%, more preferably at least 20%, preferably between 20% and 40%, of the length of the bottom 11. The length of the bottom 11 extends in the longitudinal direction L of the base body 6.

FIGS. 4 and 10 show that the contact means 5 have at least one angulation 17 in the area of the inner section 8, i.e. in the interior of the insulating housing 2. The angulation 17 can be curved. FIG. 10 shows that the angulation 17 is formed in such a way that, at least in sections, an S-shaped formation of the contact means 5 is formed in cross section. The angulation 17 can be designed in such a way that, in the area of contact with the melting conductor 4, the inner section 8 of the contact means 5 is arranged at least in some areas at least essentially parallel to the respective directly adjacent wall—in the embodiment examples shown in FIGS. 4 and 10 at least essentially parallel to the directly adjacent front sides 12, 13.

Furthermore, in the embodiment example shown in FIG. 10, the angulation 17 enables a widened contact surface of the outer section 9 and also a secure fixing of the contact means 5 in the base body 6, so that an undesired falling out or detachment of the contact means 5 from the base body 6 can be avoided. At least one angulation 17 of the inner section 8 is therefore particularly preferred in the case of a positive and/or frictional connection between the contact means 5 and the base body 6.

In principle, the contact means 5 can also be at least substantially L-shaped in cross-section, as shown schematically in FIGS. 8 and 9, or at least substantially T-shaped, as shown schematically in FIGS. 11 and 12.

The contact means 5 shown in FIG. 8b is formed at least substantially in one piece. In this respect, the outer section 9 may be formed at least substantially integrally with the inner section 8. Alternatively or additionally, it may be provided that the inner section 8 has the same material as the outer section 9 or is made of the same material. In particular, the inner section 8 or the outer section 9 have as material metal or consist thereof. The inner and outer sections 8, 9 may be formed as metal parts. The metal is electrically conductive in each case.

FIG. 8b shows that the inner section 8 has a receptacle 18. The receptacle 18 may be formed as a notch and/or recess. As shown in FIG. 8b, the receptacle 18 serves to arrange the melting conductor 4, namely an end-side region 19 of the melting conductor 4. The end-side region 19 may—but need not—comprise the front side of the melting conductor 4. In the embodiment example shown in FIG. 7, it is provided that the melting conductor 4 is arranged with its end-side regions 19 and the respective front side in the receptacle 18.

FIG. 4 shows that the melting conductor 4 protrudes at least partially beyond the receptacle 18.

The receptacle 18 shown in FIG. 8b can be designed in such a way that the melting conductor 4 is fixed, in particular clamped, in a frictionally engaged manner on at least one end-side region 19.

The melting conductor 4 shown in FIGS. 11 and 12 is materially connected to the inner section 8. A fastening means 20, in particular a solder connection and/or a conductive adhesive connection, can be provided for the material connection of the melting conductor 4.

The contact means 5 shown in FIG. 10 and/or the contact means 5 shown in FIG. 9 (namely two contact means 5, one being associated in each case with an end-side region 19 of the melting conductor 4) are inseparably connected to the insulating housing 2, namely to the base body 6. This connection can be achieved during the manufacture of the base body 6, for example by using an injection molding process to manufacture the base body 6, wherein the contact means 5 are incorporated into the material of the base body 6.

The contact means 5 shown in FIG. 9 is detachably connected to the base body 6, in particular inserted into the base body 6.

Not shown is that the cavity 3 may be at least partially filled with an extinguishing agent, in particular with an extinguishing sand.

FIG. 4 shows that the base body 6 has a recess 21, preferably in the center. The recess 21 can be arranged between the inner sections 8 of the contact means 5. The recess 21 can ultimately increase the free space below the melting conductor 4, wherein this free space formed can be filled with the extinguishing agent, for example.

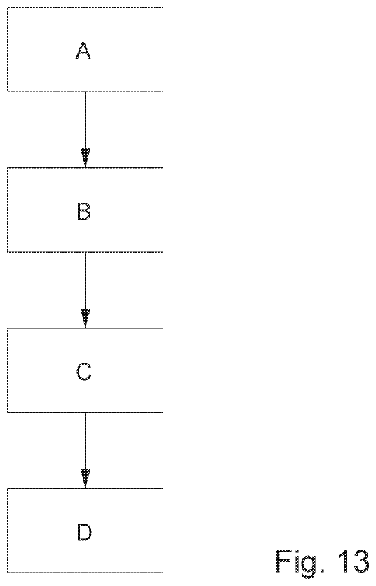

FIG. 13 schematically illustrates a process sequence for producing a fuse 1 according to one of the preceding embodiments. The method comprises method steps A to D, which are carried out in sequence in the embodiment shown in FIG. 13. It is understood, however, that the sequence of the method steps may well vary in further process sequences.

In method step A, the insulating housing 2, the melting conductor 4 and the contact means 5 are provided. In principle, it is also possible for the insulating housing 2 to be formed after the contact means 5 have been provided, for example by producing the base body 6 around the contact means 5 by means of an injection molding process.

In method step B, the melting conductor 4 is inserted into the cavity 3 of the base body 6 of the insulating housing 2. In particular, the melting conductor 4 is inserted into the cavity 3 via the insertion opening 16 of the base body 6. The insertion opening 16 extends in the longitudinal direction L of the base body 6. In addition, the length of the insertion opening 16 corresponds in particular at least to the length of the melting conductor 4 in the state of use.

In method step C, it is provided that the melting conductor 4, in particular two end-side regions 19 of the melting conductor 4, are connected to the inner sections 8 of the contact means 5. In particular, two inner sections 8 of two contact means 5 are provided, each of which can be connected to an end-side region 19 of the melting conductor 4. In this case, the end-side region 19 can be arranged in a receptacle 18 of the inner sections 8 and can be connected thereto in a form-fitting, friction-fitting and/or material-fitting manner

Not shown in more detail is that the melting conductor 4 is clamped at at least one end-side region 19.

In addition, it is not shown in more detail that a fastening means 20 can be used to connect the melting conductor 4 to the contact means 5, which is in particular a solder connection and/or a conductive adhesive connection. In this case, the end-side region 19 can be connected to the inner section 8 or to a part of the inner section 8 via the fastening means 20 in a materially bonded manner in a receptacle 18 in such a way that a secure fixing of the melting conductor 4 to the inner sections 8 is achieved.

Subsequently, in method step D, the cavity 3 of the base body 6, in particular the insertion opening 16, is closed with the lid 7. The lid 7 can be connected to the base body 6 in a detachable or fixed manner. In particular, the lid 7 can latch with the base body 6 and/or engage in the base body 6.

After method step A, the contact means 5 can be inserted into the insulating housing 2, in particular into the base body 6, and/or detachably connected to the insulating housing 2, in particular to the base body 6. Alternatively, as explained previously, it is possible for the contact means 5 to be connected, preferably inseparably, to the insulating housing 2 and/or the base body 6 already during the manufacture of the insulating housing 2 and/or the base body 6.

It is not shown in more detail that the cavity 3 can be filled with an extinguishing agent. The extinguishing agent can be introduced, for example, via the insertion opening 16. The extinguishing agent can be introduced into the cavity 3 before or after introduction of the melting conductor 4, but in any case before method step D.

### LIST OF REFERENCE SIGNS

1 Fuse
2 Insulating housing
3 Cavity
4 Melting conductor
5 Contact means
6 Base body
7 Lid
8 Inner section
9 Outer section
10 Outer side
11 Bottom
12 Front side of 6
13 Front side of 6
14 Longitudinal side from 6
15 Longitudinal side from 6
16 Insertion opening
17 Angulation
18 Reception
19 End-side region
20 Fastening means
21 Receptacle
L Longitudinal extension of 6
B Longitudinal extension from 7
C Longitudinal extension from 16

1. A fuse, in particular SMD fuse, with an insulating housing having a cavity, a melting conductor arranged in the cavity of the insulating housing, and contact means electrically connected to the melting conductor for making contact with the outside of the fuse;
wherein the insulating housing comprises a base body having the cavity and a lid closing the cavity of the base body; and
wherein the contact means are each arranged with an inner section electrically connected to the melting conductor in the interior of the insulating housing and with an outer section on the outer side of the insulating housing, preferably of the base body.

2. The fuse according to claim 1, wherein the base body has an elongated cuboid shape with a bottom, front sides and longitudinal sides.

3. The fuse according to claim 1, wherein the outer section at least partially, preferably completely, abuts and/or directly adjoins the outer side of the insulating housing, preferably of the base body, and/or wherein the outer section at least regionally turns over the base body and/or the insulating housing.

4. The fuse according to claim 1, wherein in each case the inner section of the contact means for making electrical contact with the melting conductor is adjacent to the cavity and/or projects into the cavity.

5. The fuse according to claim 1, wherein the cavity has an insertion opening for inserting the melting conductor, in particular wherein the insertion opening can be completely closed by the lid.

6. The fuse according to claim 5, wherein the insertion opening is elongated, the longitudinal extension (C) of the insertion opening running in the longitudinal extension (L) of the base body.

7. The fuse according to claim 1, wherein the lid rests on the base body and/or wherein the lid turns the base body upside down at least in some areas, preferably on all edge sides; and/or
wherein the lid is firmly connected, in particular materially connected, to the base body and/or wherein the lid can be connected to the base body in a formfitting and/or friction-fitting manner, preferably in a latching manner.

8. The fuse according to claim 1, wherein the contact means is guided through the base body into the interior of the insulating housing; and/or
wherein the contact means is formed in one piece; and/or
wherein the contact means, in particular the inner and/or outer section, comprises metal and/or consists thereof.

9. The fuse according to claim 1, wherein the inner section of the contact means has a receptacle, in particular a notch and/or recess, for the respective arrangement of an end-side region of the melting conductor.

10. The fuse according to claim 9, wherein the inner section and/or the receptacle of the inner section is designed in such a way that the melting conductor is fixed, in particular clamped, in a frictionally engaged manner at least at one end-side region and/or is connected in a materially engaged manner.

11. The fuse according to one of the preceding claims, claim 10, wherein the inner section of the respective contact means is electrically connected to the end-side region of the melting conductor via a fastening means, in particular a solder connection, a conductive adhesive connection and/or a crimped connection.

12. The fuse according to claim 1, wherein the contact means are inserted into the insulating housing, in particular into the base body, and/or are detachably connected to the insulating housing, in particular to the base body, or wherein the contact means are firmly, preferably inseparably, connected to the insulating housing, in particular to the base body.

13. The fuse according to claim 1, wherein the cavity is at least partially filled with an extinguishing agent.

14. A method of producing a fuse according to claim 1, wherein the method comprises the following method steps, which are preferably carried out in succession:
A) Providing the insulating housing, the melting conductor and the contact means;
B) Inserting the melting conductor into the cavity of the base body of the insulating housing;
C) Electrical connection of the melting conductor to the inner sections of the contact means; and
D) Closing the cavity of the base body with the lid.

15. The method according to claim 14, wherein the melting conductor is fixed, in particular clamped, at at least one end-side region in a frictionally engaged manner and/or is connected in a materially engaged manner to the inner section and/or a receptacle of the inner section.

16. The method according to claim 14, wherein the contact means are inserted into the insulating housing, in particular into the base body, and/or are detachably connected to the insulating housing, in particular to the base body, or wherein the contact means are firmly, preferably inseparably, connected to the insulating housing, in particular to the base body.
